(19) United States
(12) Patent Application Publication
(10) Pub. No.: US 2016/0298706 A1
(43) Pub. Date: Oct. 13, 2016

(54) Floating Disc Brake Rotor Assemble and Method for Attaching Same

(71) Applicant: Charles B. Rau, III, Gig Harbor, WA (US)

(72) Inventor: Charles B. Rau, III, Gig Harbor, WA (US)

(21) Appl. No.: 15/188,070

(22) Filed: Jun. 21, 2016

Related U.S. Application Data
(60) Provisional application No. 62/183,065, filed on Jun. 22, 2015.
(60) Provisional application No. 62/015,648, filed on Jun. 23, 2014.
(60) Provisional application No. 61/840,337, filed on Jun. 27, 2013.

(51) Int. Cl. F16D 65/12

(52) U.S. Cl. CPC F16D 65/123; F16D 2065/1304

(57) ABSTRACT

A disc brake rotor assembly comprises a rotor hat having a mounting surface defining a circumferential edge and a rotational axis, and wherein the mounting surface further defines a circumferentially oriented wall which has a first shape. A friction ring having a friction surface radially outward of a medial orifice having a circumferential outer edge which has a second shape that is complementary to the first shape defined by the rotor hat. And wherein, a first orientation of the rotor hat relative to the friction ring impedes rotational movement of rotor hat and friction ring, one relative to the other, while simultaneously permitting limited coaxial movement of the friction ring relative to the rotor hat while in a second non-engaged orientation.

### RELATED APPLICATIONS

This non-provisional Patent Application claims the benefit of earlier filed U.S. Provisional Patent Applications No. 62/183,065 filed Jun. 22, 2015, and 62/015,648 filed on Jun. 23, 2014 and 61/840,337 filed on Jun. 27, 2013 all titled FLOATING DISC BRAKE ROTOR ASSEMBLY AND METHOD FOR ATTACHING SAME. By this reference the entire contents of all the aforementioned earlier filed US Provisional Patent Applications are incorporated herein.

### BACKGROUND OF THE INVENTION

1. Field of Invention

The present invention relates to braking assemblies for articles of interest including, but not limited to, vehicles, aircraft and power tools, and more particularly pertains to a disc brake rotor assembly having a friction ring and a rotor hat that are attached to one another in a “floating” arrangement that allows for limited axial movement between the friction ring and the rotor hat.

2. Discussion of Related Art

Increasing fuel prices, fuel economy and emission standards provide incentive to reduce the mass of vehicles by substituting light weight components in place of heavy steel or cast iron components. A large opportunity for such mass/weight reduction exists in the vehicles' braking system.

A disc-and-caliper braking system is increasingly common on motor vehicles, and in particular, is becoming more common on military and commercial vehicles. In such a system, braking is effected by high pressure hydraulic fluid forcing one or more pistons in a caliper to press a pair of brake pads against a friction surface of a brake rotor. The brake rotor is fixedly connected to, and rotates at the same speed as the wheel and/or axle of the vehicle. The brake rotor traditionally has been fabricated from a ferrous-based material such as cast Iron or steel. These materials have worked adequately for many years, but suffer from relatively high weight.

In recent times, brake designers have experimented with brake components based on materials other than traditional cast iron or steel, such as aluminum and its alloys. Aluminum is much lighter than iron or steel, but cannot operate at as high temperature as iron or steel, which is a significant drawback in a braking system where operating temperatures can regularly exceed 600 degrees Celsius. Aluminum also has a much higher co-efficient of thermal expansion (CTE) than does iron or steel. Aluminum brake components that are constrained as they heat up under braking action are at risk of warping or buckling. Aluminum also has a much higher thermal conductivity than does iron or steel. As such, if the heat of braking is not dissipated into the surrounding air, the heat will more quickly travel into the surrounding structure to which it is mounted, which could have an adverse effect on other component materials, fluids and lubricants.

Accordingly, many brake rotor designs rely on vents to help dissipate heat into the surrounding air. Incorporating vents into the brake rotor adds complexity to the casting and therefore cost. To present a uniform friction surface, the vent designs typically are internal to the brake rotor. Brake rotors typically are made by a casting process. Unless the brake rotor is cast in two half-disc shaped units that are later assembled by welding and subsequent finishing, the formation of internal vents in a brake rotor requires the casting to be completed using sand cores or similar cores, with the cores subsequently being removed/destroyed to create the vents. U.S. Pat. No. 6,536,564 to Garfinkel, et al. addresses the problem of casting vents in a vented brake rotor design.

Another problem with using a lightweight metal such as aluminum is that aluminum is softer than iron or steel, and thus wears out faster in frictional contact with a brake pad. Accordingly, some brake designers have opted to stay with a traditional material such as steel or cast iron for the friction surface while using a light weight material such as aluminum for the wheel mounting portion of the brake rotor which is commonly referred to as a “rotor hat.”

One drawback with this approach is that when dissimilar materials are used, there can be a large difference in the coefficient of thermal expansion (CTE) between the two materials of the friction surface and the rotor hat region. As such, the two different materials of the friction portion and the rotor hat portion heat up faster and to higher temperatures. Since the two regions are typically rigidly attached to one another, this dissimilar heat gain and thermal expansion can result in failure, typically warping, buckling, cracking or complete separation which may lead to catastrophic accidents if the braking system fails.

One modification that at least partially addresses this drawback is to divide the disc brake rotor assembly into two separate components, namely as an annular ring friction surface (the “friction ring”), and a central mounting hub region, or “rotor hat”. The two components are then lightly or loosely attached to one another, at least with respect to movement in an axial direction or dimension, so that the two components can move somewhat, or “float” with respect to one another in the axial dimension. The terms “hat” and “hub” are used interchangeably in this document.

U.S. Pat. No. 6,997,292 to Burgoon (2006), illustrates an alleged “floating” attachment arrangement. In Burgoon the brake disc is separated into a friction ring portion and a wheel mount or “hat” portion, with the two portions connected to one another using a “bobbin assembly.” The friction ring has a flange formed as a series of spaced tabs or “splines”, and the “bobbin assembly” is bolted to the rotor hat portion with the friction ring splines clamped therebetween. The “bobbin assembly” is complex, involving bolts, spring clips, and crush zones.

U.S. Pat. No. 6,957,726 to Gehrs (2005) discloses another floating attachment between a friction ring and a rotor hub in a disc brake assembly. Here, the attachment mechanism consists of a pin and spring assembly. Torque is transferred from the friction ring portion to the rotor hat portion by means of “tooth-like protruding members” along an inner edge of the friction ring. These members are very similar to the tabs or splines of Burgoon.

Another known problem in known two-piece disc brake rotor systems concerns transferring torque from the friction ring portion to the rotor hat portion. The spaced tabs, tooth-like protruding members or splines may be satisfactory for friction ring portions made from traditional materials such as cast iron, but can be too complex to easily fabricate from somewhat non-traditional materials such as cast metal matrix composite (“MMC”) or carbon composites. Thus, to take advantage of the performance advantages of such materials, certain design modifications may be beneficial, or may need to be made.

Another problem with the spline attachment arrangement is that the contact area between opposing surfaces is relatively small, leading to high localized pressure and accelerated wear.

U.S. Pat. No. 4,930,606 to Sporzynski (1990) discloses a disc brake rotor having a non-planar hat section that engages the friction ring portion using a number of “flat” sections on the otherwise circular periphery. The friction ring is cast around the non-planar periphery, thereby locking the disc to the rotor hat. Thus, this design is not a floating design.

U.S. Patent App. Pub 2006/0201760 to Brunetti (2006) discloses a hub and braking rotor unit that uses oval or ellipse shapes to transfer torque between the friction ring and rotor hat. The unit also features rivets to prevent axial movement between the friction ring and the rotor hat, so this design is not floating, either.

U.S. Pat. No. 6,230,848 to Niebling (2002) discloses a wheel bearing that connects to a braking element such as disc or drum. Torque is transformed from braking element to the bearing by a polygon having a small number of sides. Axially, the braking element rests against a flange, supplemented by bolts, or “other fasteners known in the art.” In this example as well, the friction ring is fixedly attached to the rotor hat.

What is needed is a disc brake rotor assembly that simultaneously or concurrently addresses these and other various problems. The instant invention addresses various these issues and problems.

### SUMMARY OF THE INVENTION

A disc brake rotor assembly for an object of interest, comprises a rotor hat having a mounting surface which defines a circumferential edge, and which further has a rotational axis, and wherein the rotor hat further defines a plurality of spacedly arrayed apertures for wheel lugs, and wherein the mounting surface of the rotor hat further defines a circumferentially oriented wall which has a first shape. A friction ring having a friction surface which is oriented radially outwardly relative to a medial orifice which is defined by the friction ring, and wherein the medial orifice has a circumferentially oriented outer edge which has a second shape which is complementary to the first shape defined by the rotor hat. The friction ring has a rotational axis which is oriented in a coaxially orientation relative to the rotational axis of the rotor hat, and wherein the friction ring is coaxially moveable relative to the rotor hat, and wherein coaxial movement of the friction ring and rotor hat, in a given direction positions the friction ring and rotor hat in a first orientation which causes the wall of the rotor having the first shape to releasably, matingly engage the outer edge of the friction ring having the complementary second shape. And wherein, the first orientation of the rotor hat and friction ring impedes rotational movement of rotor hat and friction ring, one relative to the other, while simultaneously permitting limited coaxial movement of the friction ring relative to the rotor hat to a second non-engaged orientation.

A second aspect of the present invention is a disc brake rotor assembly for a vehicle.

A third aspect of the present invention is a disc brake rotor assembly having a flange carried on the wall opposite the mounting surface to limit axial movement of the friction ring.

A fourth aspect of the present Invention is a disc brake rotor assembly having a circumferentially extending groove defined in the wall spaced apart from the mounting surface, and a fastener releasable engageable within the circumferentially extending groove to substantially secure the friction ring to the rotor hat and to limit axial movement therebetween.

A fifth aspect of the present invention is a disc brake rotor assembly wherein the fastener is a wave spring.

A sixth aspect of the present invention is a disc brake rotor assembly wherein the fastener is a split ring washer.

A seventh aspect of the present invention is a disc brake rotor assembly wherein the first shape is elliptical and the second shape is elliptical.

An eighth aspect of the present invention is a disc brake rotor assembly wherein the first shape is a non-circular and the second shape is a non-circular.

A ninth aspect of the present invention is a disc brake rotor assembly wherein the friction ring has two spaced apart and opposing friction surfaces.

A tenth aspect of the present invention is a disc brake rotor assembly wherein the friction ring is retained on the rotor hat by plural fasteners positioned adjacent to each friction surface of the friction ring.

An eleventh aspect of the present invention is a disc brake rotor assembly having a friction ring mounting surface defined in the rotor hat wall, the friction ring mating surface having two spaced apart edges and a groove defined in the rotor hat wall adjacent each edge of the friction ring mounting surface.

A twelfth aspect of the present invention is a disc brake rotor assembly wherein the friction ring and rotor hat rotate on a common axis of rotation and the friction ring transfers torque to the rotor hat by means of the releasably engageable complimentary shapes.

A thirteenth aspect of the present Invention is a disc brake rotor assembly wherein the wall is perpendicular to the mounting surface.

A fourteenth aspect of the present invention is a disc brake rotor assembly wherein the wall is not perpendicular to the mounting surface.

A fifteenth aspect of the present invention is a disc brake rotor assembly for an article of interest, which may be a vehicle, having a rotor hat with a generally planar mounting surface defining a rotational axis and plural spacedly arrayed wheel lug apertures, the rotor hat further having a circumferentially extending wall structurally attached to an outer edge of the mounting surface, the circumferentially extending wall defining a first shape. A friction ring having a friction surface radially outward of a medial through orifice defined in the friction ring, the medial orifice having a circumferentially extending outer edge defining a second shape, and the first shape and the second shape are complementary and releasably matingly engage with one another in one plane that prevents axial rotational movement therebetween while preserving limited axial movement of the friction ring relative to the rotor hat.

In accordance with the instant invention, a disc brake rotor assembly is provided in which a friction ring is attached to a rotor hat that mounts to the vehicle in a floating arrangement involving a simple attachment mechanism. During vehicle braking, torque is transferred in the circumferential or rotational direction from the friction ring to the rotor hat by adjacent mating surfaces that have non-circular geometries. For example, a circumferential outer edge of the rotor hat may be in the shape of a square, and a medial hole defined in the friction ring may be a square, sized to closely engage the square of the rotor hat.

Such a two-piece design, the friction ring and rotor hat can be standardized to some extent, thereby reducing the total number of designs (compared to the number required of a single-piece brake rotor) needed to produce disc brake rotors that fit a wide variety of vehicles. This will be of great value to parts stockers and suppliers, who have only a finite amount of space available to store parts, and who incur costs associated with the storage and shipping of such parts.

### BRIEF DESCRIPTIONS OF THE FIGURES

FIG. 1A is an orthographic side view of a friction ring showing one embodiment of a non-circular geometry of the medial orifice.

FIG. 1B is an orthographic cross section view of the friction ring of FIG. 1A taken on line 1B-1B.

FIG. 1C is an orthographic edge view of the friction ring of FIG. 1A.

FIG. 2A is an isometric side and edge view of a rotor hat showing one embodiment of a non-circular geometry of the circumferential edge for mating engagement with the friction ring of FIG. 1A.

FIG. 2B is an orthographic side view of the rotor hat of FIG. 2A.

FIG. 2C is an orthographic cross section view of the rotor hat of FIG. 2B taken on line 2C-2C.

FIG. 2D is an orthographic edge view of the rotor hat of FIG. 2B.

FIG. 3A is an orthographic side view of the rotor hat of FIG. 2B mated within the medial orifice defined by the friction ring of FIG. 1A showing the engagement of the non-circular geometry.

FIG. 3B is an orthographic cross section view of the mated rotor hat and friction ring of FIG. 3A taken on line 3B-3B.

FIG. 4A is an isometric side and edge view of a rotor hat having a circumferential flange.

FIG. 4B is an orthographic side view of the rotor hat of FIG. 4A.

FIG. 4C is an orthographic cross section view of the rotor hat of FIG. 4B taken on line 4C-4C.

FIG. 4D is an orthographic edge view of the rotor hat of FIG. 4A.

FIG. 5 is an enlarged orthographic partial cut-away cross section view of a flanged rotor hat carrying a friction ring showing the attachment therebetween that provides for limited axial movement therebetween.

FIG. 6A is an orthographic partial cut-away cross section view of an alternative embodiment of a flanged rotor hat carrying a friction ring having a mating surface that is only adjacent to the rotor hat flange.

FIG. 6B is an orthographic partial cut-away cross section view of another alternative embodiment of a flanged rotor hat carrying a friction ring having a mating surface that is centralized between the two friction surfaces of the friction ring.

FIG. 6C is an orthographic partial cut-away cross section view of another embodiment of a flanged rotor hat carrying a friction ring having a mating surface that is spaced apart from the rotor hat flange.

### DETAILED DESCRIPTION OF THE INVENTION

A floating disc brake rotor assembly and method for attaching the same generally provides a friction ring 12 and a rotor hat 20 that are releasably interconnected to one another and that have mating complementary geometries so that torque forces applied to the friction ring 12 are communicated to the rotor hat 20 during braking of an article of interest, while preserving limited axial movement between the friction ring 12 and the rotor hat 20 and allowing for replacement of the friction ring 12 and the rotor hat 20 separately from one another.

Various of the embodiments herein are described with reference to an externally vented 19 friction ring 12 of a disc brake rotor assembly, as described above. External vents 19, however, are not critical to the practice of the present invention, and other friction ring 12 styles or designs such as internally vented or solid (non-vented) friction ring 12 will work entirely satisfactorily with the rotor hat 20.

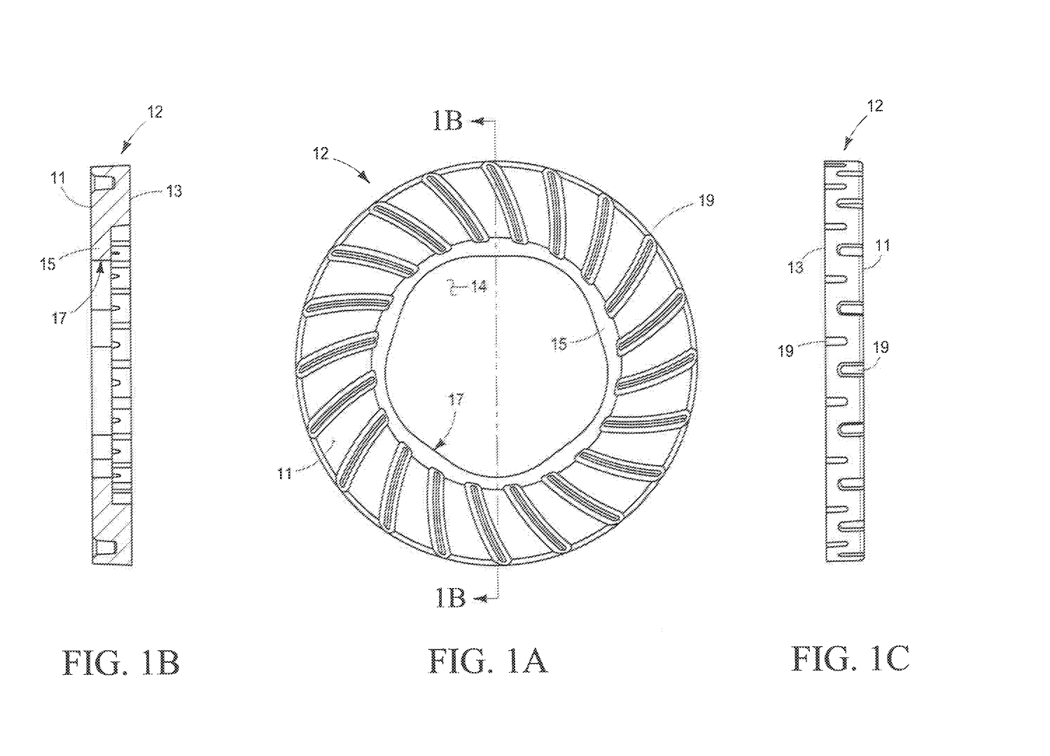

Referring first to FIGS. 1A-1C, the friction ring 12 is disc shaped defining a medial orifice 14 and is characterized by flat, parallel opposing friction surfaces 11 and 13 radially outward of the medial orifice 14. The friction surfaces 11, 13 may be interrupted periodically by external vents 19. In alternate embodiments, the friction ring 12 may be solid (non-vented), or may be internally vented. The medial orifice 14 of the friction ring 12 is characterized by a radially reduced flange 15, which may be an integral part of the friction ring 12. A circumferentially oriented outer edge 17 of the flange 15 defines a second shape that is not a circle.

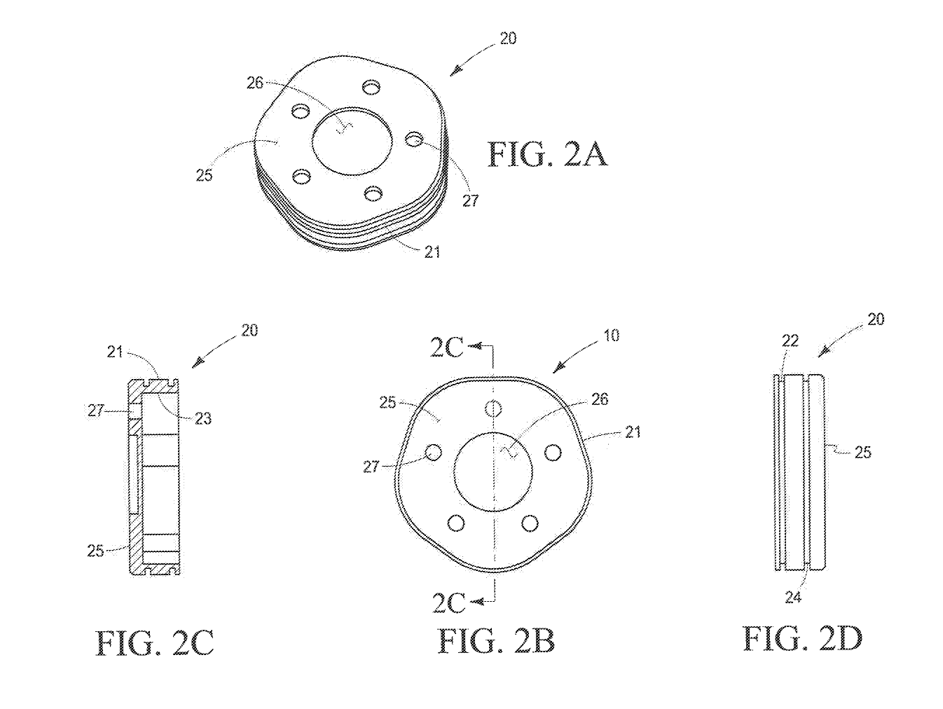

FIGS. 2A-2D illustrate a first embodiment of the rotor hat 20 of the two-piece floating disc brake rotor assembly. The rotor hat 20 is somewhat “bowl-like” in configuration defining an interior cavity and having a circumferentially oriented wall 21 that is parallel to and opposing an inner circumferential wall 23, and both walls 21, 23 extend upwardly relative to a generally planar mounting surface 25. A plurality of spacedly arrayed wheel lug apertures 27 are defined in the mounting surface 25 so that the rotor hat 20 and the assembled disc brake rotor assembly can fit onto the wheel lugs which in turn hold a wheel (not shown) onto a vehicle (not shown). The function or purpose of first groove 22 and second groove 24 which are defined in the outer circumferential wall 21 will be explained later. The main function of the rotor hat 20 of the instant invention is to hold the friction ring 12 a fixed distance away from the vehicle wheel (not shown), the distance being sufficient that a brake caliper (not shown) can be mounted about the friction ring 12 with brake pads (not shown) arranged to engage the friction surfaces 11, 13, without interfering with the vehicle wheel.

The circumferentially oriented wall 21 of the rotor hat 20 has a first shape that is sized and to matingly engage with the circumferentially oriented outer edge 17 of the medial orifice 14 of the friction ring 12 with less than one millimeter of clearance therebetween. During braking of the vehicle, the close tolerance ensures a large contact area between the respective surfaces 21, 17; that is, that most of the circumferentially oriented wall 21 of the rotor hat 20 is in continuous frictional contact with circumferentially oriented outer edge 17 of the friction ring 12.

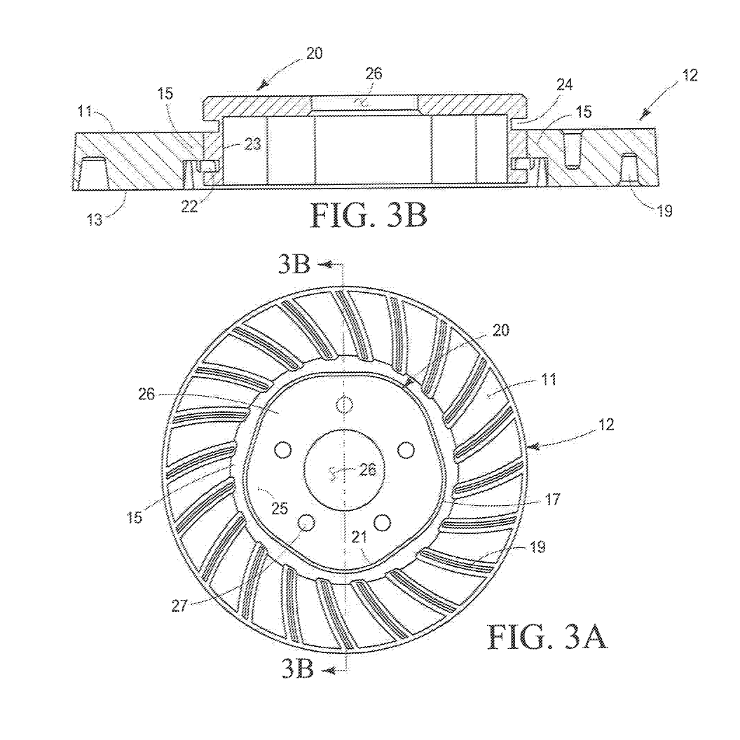

Referring now to FIGS. 3A and 3B, friction ring 12 and rotor hat 20 have been assembled together as they would for mounting on a vehicle. First groove 22 and second grove 24 are defined in the circumferentially oriented wall 21 and are spaced apart and lie on opposite sides of the friction ring 12. Spring clips 52 or other fasteners (not shown) are releasably inserted into the grooves 22, 24. The fasteners 52 allow a small amount of movement in the axial direction (on the order of a millimeter or so) of the friction ring 12 with respect to the rotor hat 20, but no more. In this way, axial movement of one portion relative to the other is largely prevented, but a small amount of such movement is permitted, for example, to accommodate strain due to thermal expansion mismatch, whether caused by differential temperature, differential CTE, or both. Thus, one portion is said to “float” with respect to the other portion of the disc brake rotor assembly.

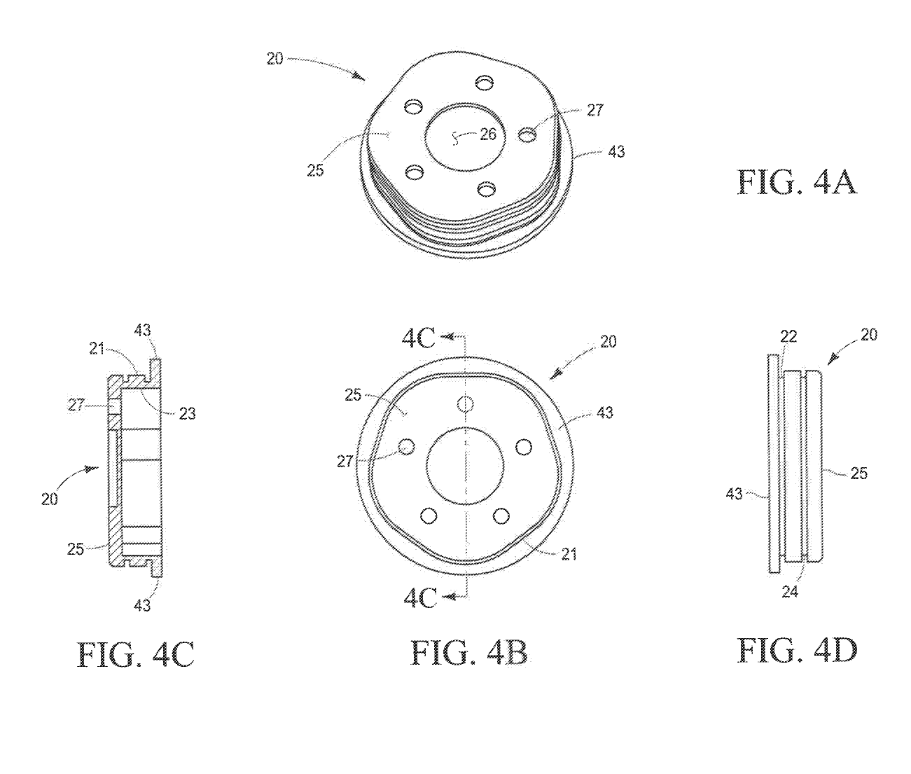

FIGS. 4A-4D illustrate an alternate embodiment of the rotor hat 20 of the two-piece floating disc brake rotor assembly. In this embodiment, an annular flange 43 is carried on a side of the rotor hat 20 opposite the mounting surface 25. (See FIGS. 4C, 4D.) The flange 43 may interchangeably be referred to as a “retaining flange”, “mounting flange” or “positioning flange.” It provides a “stop” beyond which the friction ring 12 cannot move in the axial direction relative to the rotor hat 20.

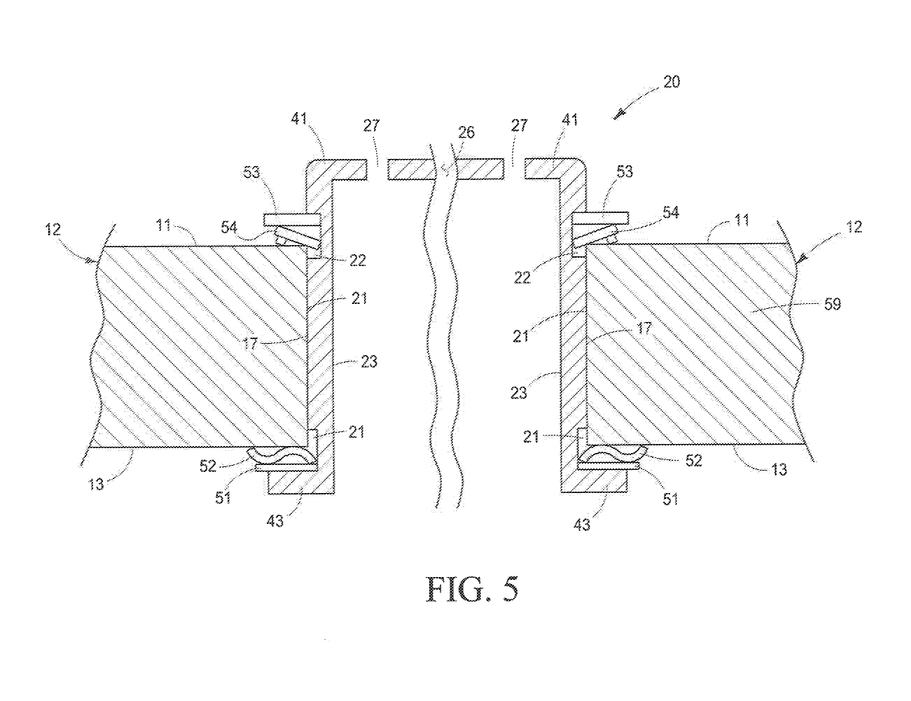

FIG. 5 shows a partial cut-away orthographic cross-sectional view of a friction ring 12 and rotor hat 20 assembled together as they would be for mounting on a vehicle. Unlike the rotor hat 20 shown in FIG. 2, here, the friction ring 12 cannot move axially past retaining flange 43. Thus, the friction ring 12 and rotor hat 20 can be assembled in only one direction-moving the friction ring 12 from left to right with respect to the rotor hat 20 shown in FIG. 4C. In other words, retaining flange 43 axially and laterally supports the friction ring 12.

FIG. 5 also illustrates a solid friction ring 12 embodiment of the invention. In addition, FIG. 5 illustrates a means for fastening the friction ring 12 to the rotor hat 20. Specifically, FIG. 5 shows a retainer clip 51, 53 located in the grooves 21, 24 on each side of the friction ring 12. Further, between the retainer clip 51, 53 and the friction surfaces 11, 13 may be placed a crushable or deformable body such as a sandwich spring wave washer 52 or lock washer 54. In this way, the friction ring 12 and rotor hat 20 can move axially with respect to one another about 25 one-thousandths to 35 one-thousandths of an inch (1.0-1.4 mm) in the axial direction.

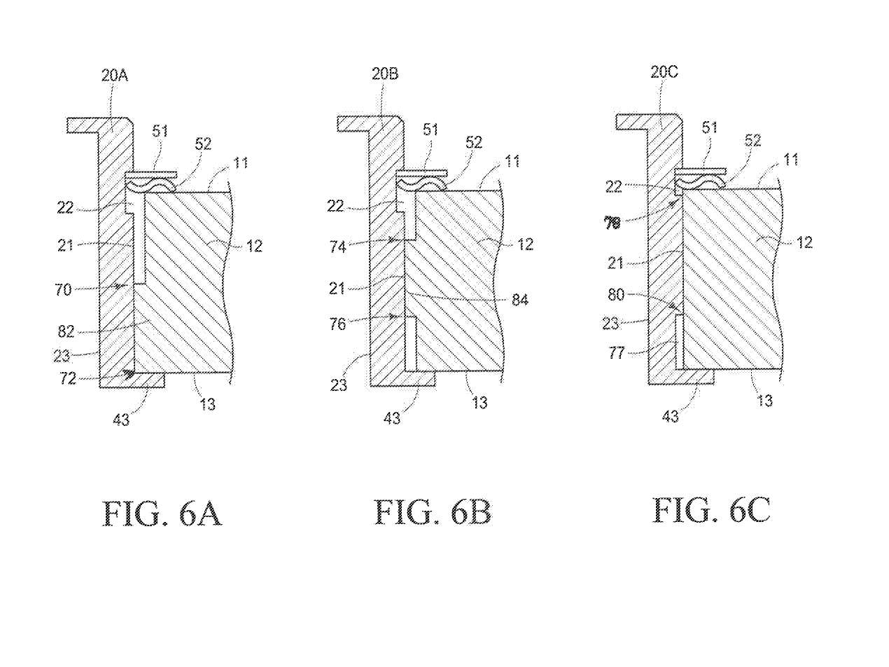

FIG. 6 shows that the mating surfaces 17, 21 or contact area between the rotor hat 20 and the friction ring 12 need not span the entire surface width of the friction ring 12. FIGS. 6A-6C depict a series of variations on FIG. 5, and showing only the right-hand portion of the rotor hat 20, friction ring 12 interface.

What FIGS. 6A-6C have in common is a rotor hat 20A, 20B, 20C with a flange 43 on the inboard side of the friction ring 12, with groove 22 corresponding to the outboard side (vehicle wheel) of the friction ring 12, and retainer clip 51 and spring wave washer 52 located in the groove 22 to hold friction ring 12 axially in place with “float.” In FIG. 6A, it is only an inboard portion (opposite the vehicle wheel) between point 70 and point 72 that engages the opposing complementary shaped mounting surface 21 on rotor hat 20A. In FIG. 6B, it is a middle portion of inner circumferential edge 17 of friction ring 12 between point 74 and point 76 that engages the corresponding opposing complementary shaped mounting surface 21 of the rotor hat 20B. In FIG. 6C, it is only outboard portion (proximate the vehicle wheel) of friction ring 12 between point 78 and point 80 that engages the corresponding opposing complementary shaped mounting surface 21 of the rotor hat 20C. Note that inner circumferential edge 17 of friction ring 12 is uniform whereas the corresponding outer edge 21 of rotor hat 20C has groove or notch 77 defined therein. Note also that the frictionally engaging portions 82 and 84 of inner edges of friction rings 59a and 59b can be deemed to be a flange, similar to the flange 15 shown in FIGS. 1A and 1B.

Thus, it will readily be seen that, for those embodiments featuring a flange 15, 82, 84 such as a retaining, mounting or positioning flange, the flange 15, 82, 84 may be located at or near the inboard side or edge of the rotor hat 20 or friction ring 12, at or near the middle, or at or near the outboard (outer) edge of the rotor 20 hat or friction ring 12.

In addition, one skilled in the art will appreciate that, simply by defining a series of parallel spaced apart annular grooves (not shown) in the outer circumferential edge 21 of the rotor hat 20, the friction ring 12 may be mounted on the rotor hat 20 at a number of different axial offsets: that is, the friction ring 12 may be mounted near the mounting surface 25 of the rotor hat 20, or near the rotor hat's 20 opposite surface. Thus, such an “adjustable” two-piece disc brake rotor assembly can be assembled to mimic at least some of the critical dimensions of a plurality of original equipment brake rotors. By making each of the rotor hat 20 and friction ring 12 in several sizes and widths or thicknesses, one can also see that a large number of original equipment brake rotors can be duplicated in those critical dimensions. Thus, a large number of brake rotor designs can be accommodated with a relatively small number of rotor hat 20 and friction ring 12 designs. For those who have to ship, stock and keep track of such brake rotor parts, this will be of great value.

In known two-piece disc brake rotor designs, the mating surfaces 17, 21 are the circumferential surfaces of the complementary shape of the rotor hat 20 and the friction ring 12 that immediately oppose one another, and ideally are in complete or nearly complete frictional contact with one another. These inner and outer mating surfaces 17, 21 define complementary engaging geometry. FIG. 5 shows a design where the width of the rotor hat's 20 outer circumferential edge 21 is approximately the same as the width of the friction ring's 12 inner circumferential edge 17. Although such a design is efficient in maximizing the contact area between the rotor hat 20 and the friction ring 12, it is not required that they be of the same width. Depending on design requirements and materials properties of each component, an outer circumferential edge of the rotor hat 20 may be significantly larger or smaller that the width of the inner circumferential edge 17 of the friction ring 12. Preferably, the contact area is at least about 70% to 75% of the width of the friction ring 12. Furthermore, the mounting area, or zone of contact, between the rotor hat 20 and the friction 12 ring may be located toward the plane defined by the inner (inboard) friction surface 13, toward the plane defined by the outer (outboard) friction surface 11 of the friction ring 12, or somewhere in between, for example, at or near the middle.

The preceding descriptions of embodiments provide examples of the present invention. The embodiments discussed herein are merely exemplary in nature, and are not intended to limit the scope of the invention in any manner. Rather, the description of these embodiments and methods serves to enable a person of ordinary skill in the relevant art to make, use and perform the present invention.

### Operation

In this description, which is not intended to be limiting hereto, the instant floating disc brake rotor assembly is described as it would be installed and used on a motor vehicle, such as an automobile, but it is to be expressly understood the instant invention's applicability is not limited to automobile type motor vehicles.

For installation, a motor vehicle (not shown) is positioned and oriented such that an end portion of an axle (not shown) for carrying a wheel (not shown) is exposed and is accessible and the wheel and old disc brake assembly is removed therefrom.

The rotor hat 20 is oriented so that plural wheel lug apertures 27 defined in the generally planar mounting surface 25 are aligned with the wheel lugs (not shown) carried by the vehicle axle. Upon alignment the rotor hat 20 is installed on the end of the vehicle axle so that the wheel lugs extend through the wheel lug apertures 27. After the rotor hat 20 is installed upon the wheel lugs, the friction ring 12 is oriented so that the medial orifice 14 defined therein is axially aligned with the rotor hat 20 and the second shape defined by the circumferential outer edge 17 of the friction ring 12 is aligned with the circumferentially oriented wall 21 of the rotor hat 20, and upon alignment of the two components 12, 20, the friction ring 12 is axially engaged with the rotor hat 20. The friction ring 12 is forced axially onto the rotor hat 20 to an extreme position so that one friction surface 11, 13 of the friction ring 12 frictional engages the flange 43 carried by the rotor hat 20 and the circumferentially extending groove 22 is exposed adjacent the friction surface 11, 13 opposite the flange 43. A retainer clip 51, 53 and a spring biasing fastener 52, 54 are inserted into the circumferentially extending groove 22 adjacent the friction surface 11, 13 to rotationally positionally secure the friction ring 12 to the rotor hat 20, while allowing for limited axial movement of the friction ring 12 relative to the rotor hat 20 which may be caused by thermal expansion and the like. Thereafter the brake caliper (not shown) carrying the brake pads (not shown) is fastened to the vehicle as is required to stop rotation of the friction ring 12 when breaking is applied.

The disc brake rotor assembly for an object of interest comprises a rotor hat 20 having a generally planar mounting surface 25 which defines a circumferential edge 21, and which further has a rotational axis, and wherein the rotor hat 20 further defines a plurality of spacedly arrayed wheel lug apertures 27, and wherein the mounting surface 25 of the rotor hat 20 further defines a circumferentially oriented wall 21 which has a first shape.

A friction ring 12 having a friction surface 11, 13 which is oriented radially outwardly relative to a medial orifice 14 which is defined in the friction ring 12, and wherein the medial orifice 14 has a circumferentially oriented outer edge 17 which has a second shape which is complementary to the first shape defined by the rotor hat 20, and wherein the friction ring 12 has a rotational axis which is oriented in a coaxially orientation relative to the rotational axis of the rotor hat 20, and wherein the friction ring 12 is coaxially moveable relative to the rotor hat 20, and wherein coaxial movement of the friction ring 12 and rotor hat 20, in a given direction, positions the friction ring 12 and rotor hat 20 in a first orientation which causes the wall 21 of the rotor hat 20 having the first shape to releasably matingly engage the circumferentially oriented outer edge 17 of the friction ring 12 having the complementary second shape, and wherein the first orientation of the rotor hat 20 and friction ring 12 impedes rotational movement of rotor hat 20 and friction ring 12, one relative to the other, while simultaneously permitting coaxially movement of the friction ring 12 relative to the rotor hat 20 to a second non-engaged orientation.

The rotor hat 20 may further have a flange 43 carried on the circumferentially oriented wall 21 opposite the mounting surface 25 to limit axial movement of the friction ring 12.

Further, a circumferentially extending groove 22 defined in the circumferentially oriented wall 21 spaced apart from the mounting surface 25 releasably carries a fastener 51, 53 and a biasing wave spring 52 or biasing lock washer 54 that is releasably engageable within the circumferentially extending groove 22 to substantially secure the friction ring 12 to the rotor hat 20 and to limit axial movement therebetween.

Further still, the first shape defined by the circumferentially oriented rotor hat wall 21 and the second shape defined by the friction ring medial orifice 14 may be elliptical or otherwise non-circular.

The friction ring 12 and rotor hat 20 rotate on a common axis of rotation and the friction ring 12 transfers torque to the rotor hat 20 by means of the releasably engageable complimentary first and second shapes.

In one contemplated embodiment the circumferentially oriented wall 21 is perpendicular to the mounting surface 25 and in a second contemplated embodiment the circumferentially oriented wall 21 is not perpendicular to the mounting surface 25.

More particularly, the floating disc brake rotor assembly comprises a rotor hat 20 having a generally planar mounting surface 25 defining a rotational axis and plural spacedly arrayed wheel lug holes 27, the rotor hat 20 having a circumferentially extending wall 21 structurally attached to an outer edge of the mounting surface 25, the circumferentially extending wall 21 defining a first shape.

A friction ring 12 having two opposing friction surfaces 11, 13 radially outward of a medial through orifice 14 defined in the friction ring 12, the medial orifice 14 having a circumferentially extending outer edge 17 defining a second shape, and having a rotational axis.

The first shape and the second shape are complementary and releasably matingly engage with one another, in one plane that prevents axial rotational movement therebetween while preserving limited axial movement of the friction ring 12 relative to the rotor hat 20.

### INDUSTRIAL APPLICABILITY

The floating two-piece disc brake rotor assembly of the instant invention provides at least the following benefits over known disc brake rotor assemblies, however, not all embodiments will necessarily feature all of these benefits.

Simple geometry rather than splines (or tabs) makes the instant invention simpler to cast and simpler to machine.

There are no shear loads on fasteners 51, 53.

There is less wear from simple geometry as compared to splines/tabs.

The instant invention accommodates the thermal expansion of similar and dissimilar materials at the interface.

The friction ring 12 is self-aligning on the rotor hat 20.

The simple geometry is capable of handling higher torque loads than splines/tabs and provides for a larger contact area than splines/tabs.

Also, with a two-piece design, the friction ring 12 and rotor hat 20 portions can be standardized to some extent, thereby reducing the total number of designs (compared to the number required of a single-piece brake rotor) needed to produce disc brake rotors that fit a wide variety of automobiles, for example. This will be of great value to parts stockers and suppliers, who have only a finite amount of space available to store parts, and who incur costs associated with the storage and shipping of such parts, for example, the costs of energy and money. It will also be of value to the military, whose supply lines must transport such parts to the field of operation.

Also, the two piece floating disc brake rotor assembly, with separate friction ring 12 and rotor hat 20 enables efficient and less costly replacement of the friction ring 12 only without incurring the cost of a new rotor hat 20.

An artisan of ordinary skill will appreciate that various modifications may be made to the invention herein described without departing from the scope or spirit of the invention as defined in the appended claims.

What is claimed is:

1. A disc brake rotor assembly for an object of Interest, comprising:
a rotor hat having a mounting surface which defines a circumferential edge, and which further has a rotational axis, and wherein the rotor hat further defines a plurality of spacedly arrayed apertures, and wherein the mounting surface of the rotor hat further defines a circumferentially oriented wall which has a first shape;
a friction ring having a friction surface which is oriented radially outwardly relative to a medial orifice which is defined by the friction ring, and wherein the medial orifice has a circumferentially oriented outer edge which has a second shape which is complementary to the first shape defined by the rotor hat wall, and wherein the friction ring has a rotational axis which is oriented in a coaxially orientation relative to the rotational axis of the rotor hat, and wherein the friction ring is coaxially moveable relative to the rotor hat, and wherein coaxial movement of the friction ring and rotor hat, in a given direction positions the friction ring and rotor hat in a first orientation which causes the upwardly extending wall of the rotor having the first shape to releasably, matingly engage the outer edge of the friction ring having the complementary second shape, and wherein the first orientation of the rotor hat and friction ring impedes rotational movement of rotor hat and friction ring, one relative to the other, while simultaneously permitting coaxially movement of the friction ring relative to the rotor hat to a second non-engaged orientation.

2. The disc brake rotor assembly of claim 1 further comprising:
a flange carried on the upwardly extending wall opposite the mounting surface to limit axial movement of the friction ring.

3. The disc brake rotor assembly of claim 1 further comprising:
a circumferentially extending groove defined in the wall spaced apart from the mounting surface; and
a fastener releasable engageable within the circumferentially extending groove to substantially positionally secure the friction ring to the rotor hat and to limit axial movement therebetween.

4. The disc brake rotor assembly of claim 3 wherein the fastener is a wave spring.

5. The disc brake rotor assembly of claim 3 wherein the fastener is a split ring washer.

6. The disc brake rotor assembly of claim 1 wherein the first shape is elliptical and the second shape is elliptical.

7. The disc brake rotor assembly of claim 1 wherein the first shape is non-circular and the second shape is non-circular.

8. The disc brake rotor assembly of claim 1, wherein the friction ring is retained on the rotor hat by plural fasteners positioned adjacent to each friction surface of the friction ring.

9. The disc brake rotor assembly of claim 1 further comprising:
a friction ring mounting surface defined in the rotor hat wall, the friction ring mating surface having two spaced apart edges; and
a groove defined in the rotor hat wall adjacent each edge of the friction ring mounting surface.

10. The disc brake rotor assembly of claim 1 wherein the friction ring and rotor hat rotate on a common axis of rotation and the friction ring transfers torque to the rotor hat by means of the releasably engageable complimentary shapes.

11. The disc brake rotor assembly of claim 1 wherein the wall is perpendicular to the mounting surface.

12. The disc brake rotor assembly of claim 1 wherein the wall is not perpendicular to the mounting surface.

13. The disc brake rotor assembly of claim 1 further comprising:
plural spaced apart circumferentially extending grooves defined in the rotor hat wall.

13. A disc brake rotor assembly for an article of interest comprising:
a rotor hat having a generally planar mounting surface defining a rotational axis and plural spacedly arrayed wheel lug apertures, the rotor hat further having a circumferentially extending wall structurally attached to an outer edge of the mounting surface, the circumferentially extending wall defining a first shape;
a friction ring having a friction surface radially outward of a medial through orifice defined in the friction ring, the medial orifice having a circumferentially extending outer edge defining a second shape, and having a rotational axis; and
the first shape and the second shape are complementary and releasably matingly engage with one another in one plane that prevents axial rotational movement therebetween while preserving limited axial movement of the friction ring relative to the rotor hat.
